(19) United States
(12) Patent Application Publication
(10) Pub. No.: US 2007/0286396 A1
(43) Pub. Date: Dec. 13, 2007

(54) METHODS, DEVICES, AND INTERFACES FOR ADDRESS AUTO-ASSOCIATION

(75) Inventors: WILLIAM P. ALBERTH, PRAIRIE GROVE, IL (US); SYLVIA YU CHEN, DEERFIELD, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/420,308

(22) Filed: May 25, 2006

(51) Int. Cl. H04M 1/00; H04M 3/00

(52) U.S. Cl. 379/350

(57) ABSTRACT

Disclosed is an electronic device utility method (200), including receiving a first identifying address data input (202) via a data input device (114), initiating a first communication to the first identifying address (204), and ending the first communication to the first identifying address (206). The method includes receiving second identifying address data input (208) to initiate a second communication and determining if a predetermined condition (210) is met in ending the first communication. The second identifying address is associated with the first identifying address (214) when the second communication is initiated within a predetermined length of time from the ending of the first communication. The association between the first and second addresses is stored in a memory of the electronic device (216). The association is retrieved (406) when a subsequent communication is initiated to the first associated identifying address (402). Upon ending the subsequent communication (404), a communication is initiated to the associated second identifying address (408).

### FIELD

This disclosure relates in general to communication devices, and more particularly to automatic communication address association and retrieval in a communication device.

### BACKGROUND

Many telephone users have more than one telephone number. A user may have at least one mobile communication device such as a cellular telephone, and the user may also have one or more landline communication devices. For example, a user may have a wireless pager number, a mobile number, a landline office number, and a landline home number. When attempting to reach a user, a caller may need to call several numbers before reaching the user. Certain software is used by telephone companies to allow a caller to dial only one of the numbers, but automatically ring through to each of the lines of the user. The user would have registered a plurality of telephone numbers with the telephone company so that a caller's call can be automatically forwarded to different numbers of the user in the order specified by the user.

There are different types of circumstances where a caller may wish for automatic dialing of a plurality of telephone numbers. As discussed above, when a user has several telephone numbers at which the user may be reached, a caller may wish to automatically dial all of the user's telephone numbers in sequence until the user is contacted. If the user is not signed up for the above-mentioned telephone services, then allowing the caller to automatically ring through to each of the lines of the user may not be possible.

In another circumstance, callers oftentimes repeatedly make the same sequence of telephone calls. For example, each time when calling family and friends for arrangements, a caller may place calls in the same or similar sequence. After a caller calls a first party, the caller may immediately then place a call to a second party. Furthermore, after calling the second party, the caller may immediately thereafter call a third party. In using a communication device with a telephone book, the caller usually accesses the telephone book to obtain the telephone numbers of the first, second, and third parties to make a string of telephone calls. Accessing the telephone book can be clumsy and time consuming, and can be repetitive when the caller frequently makes the same strings of telephone calls.

In the situation where a user has a plurality of telephone numbers, a caller may wish to associate all or some of the different telephone numbers of one party so that calling their different telephone numbers may be automatic. Also, in the situation where the caller repeatedly makes the same string of telephone calls to different parties, a caller may wish to associate telephone numbers of the different parties so that calling their telephone numbers in sequence may be automatic. If a caller could create an association of sequentially dialed telephone numbers, the caller may avoid having to repetitively look up the telephone numbers.

### BRIEF DESCRIPTION OF THE DRAWINGS

FIG. 1 depicts an electronic device in accordance with an embodiment, such as a mobile communication device implemented as a cellular telephone;

FIG. 2 is a flowchart of an embodiment of a method for making an association between a first telephone number and a second telephone number;

FIG. 3 is a flowchart illustrating variations in the previously-described method embodiments;

FIG. 4 is a flowchart of an embodiment of the methods involving a plurality of previously associated numbers;

FIG. 5 depicts an embodiment of indicia on a display screen representing names associated with telephone numbers; and

FIG. 6 illustrates another embodiment of indicia on a display screen indicating that there are several arrangements of lists of numbers associated with a first telephone number.

### DETAILED DESCRIPTION

Described are methods, electronic devices, and user interfaces for associating telephone numbers of different parties and/or telephone numbers of the same party so that calling their telephone numbers in sequence may be substantially automatic. A method includes a first communication device initiating a communication, such as a telephone call, to a first identifying address, such as a telephone number. By ending the telephone call and determining if a predetermined condition is met in ending the first telephone call, and thereafter initiating a second telephone call to a second telephone number within a predetermined length of time from the ending of the first telephone call, an association between the first telephone number and the second telephone number is formed.

A device is configured to determine if an end of a first telephone call to a first telephone number and a commencement of a second telephone call to a second telephone number are within a predetermined period of time. If the calls are within a predetermined period of time, associated first and second telephone numbers may be formed. A user interface can include an annunciation device or display device for presenting indicia including first telephone call initiation indicia representing a called first telephone number and second telephone call indicia representing an automatically retrieved second telephone number associated with the first telephone number. A call to the second telephone number may be substantially automatically made. Accordingly, repetitive dialing or accessing a telephone book for those sequentially called telephone numbers can be avoided.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

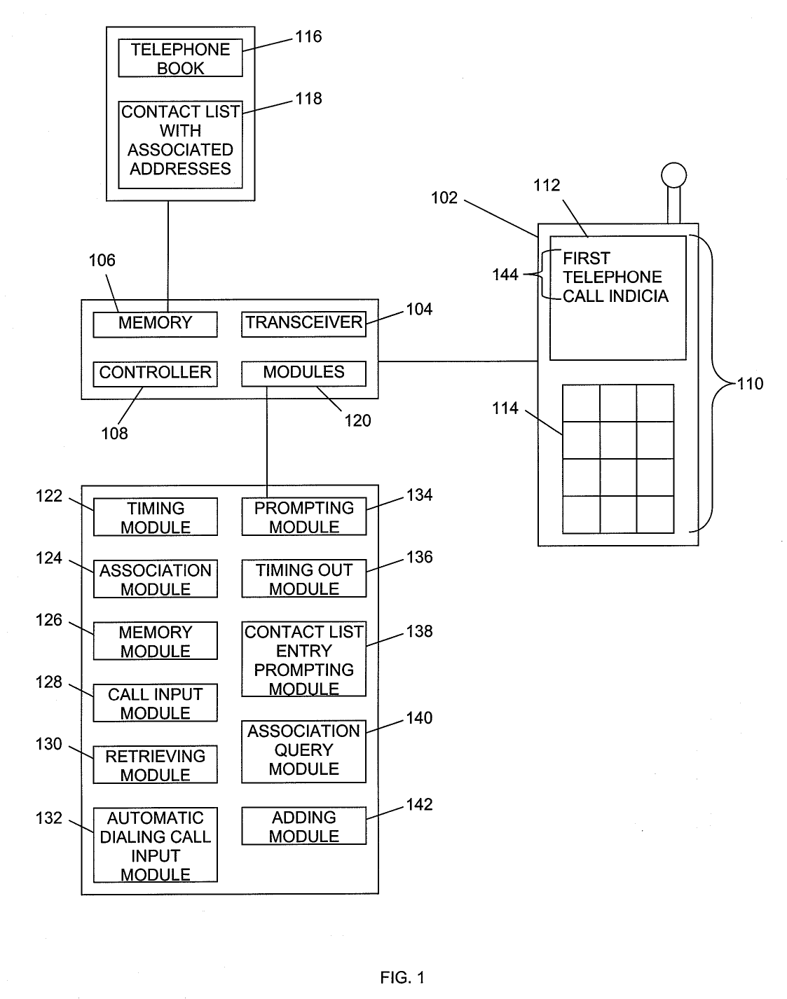

FIG. 1 depicts an electronic device in accordance with an embodiment. In this example, the electronic device is a mobile communication device that may be implemented as a cellular telephone (also called a mobile phone or mobile station). The electronic device 102 represents a wide variety of devices. Such devices include, for example, cellular telephones, cordless telephones, corded telephones, messaging devices, personal digital assistants (PDAs), notebook or laptop computers incorporating communication modems, mobile data terminals, video gaming devices incorporating wireless modems, and the like.

The electronic device 102 includes a transceiver 104 and a memory 106 coupled to a controller 108. A user interface 110 of the electronic device 102 includes an annunciation device 112 and a data or telephone number input device coupled to the controller 108. The annunciation device may be for example a display device for presenting indicia 144 or an audio output device, and the telephone data input device may be for example a keypad 114 or a microphone and speech recognition engine. It is understood that different components may be used for the same purposes. Thus, the term “indicia” refers to visual, audible, tactile, haptic, or other perceptible indications configured to intelligibly present data.

The memory 106 can include an address book or telephone book including telephone numbers entered by the caller, or any other source. An address as used in this discussion can be a telephone number, but may also include URLs, Internet protocol addresses, mobile-to-mobile communication protocols, or other types of address. In this detailed description, certain terminology refers to telephone numbers, telephone calls, and telephone books for sake of simplicity. For example, certain terms are used interchangeably in this discussion, such as an identifying address data input that can be an entered telephone number; a data input device that can be a keypad; communication that can be a telephone call; and an identifying address that can be a telephone number. It is understood that the breadth of the terms used in this discussion for simplicity's sake is not limiting to the broader meaning.

According to an embodiment, a first telephone call is initiated to a first telephone number. By determining if a predetermined condition is met upon ending the first telephone call, and thereafter initiating a second telephone call to a second telephone number within a predetermined length of time from the ending of the first telephone call, an association between the first telephone number and the second telephone number may be formed.

The memory 106 includes a list with associated telephone numbers 118. For example, the list 118 may be a database that links associated telephone numbers stored in a telephone book 116 to one another. The storage of the association between the first telephone number and the second telephone number may be in any suitable manner. For example, the link may be either a one-way pointer or a two-way pointer depending on implementation.

FIG. 1 further illustrates instruction modules 120 of the device 102. They include a timing module 122, an association module 124, a memory module 126, a call input module 128, a retrieving module 130, an automatic dialing call input module 132, a prompting module 134, a timing out module 136, a contact list entry prompting module 138, an association query module 140, and an adding module 142. The modules can carry out certain processes of the methods as described herein. The modules can be implemented in software, such as in the form of one or more sets of prestored instructions, and/or hardware, which can facilitate the operation of the electronic device as discussed below. The modules may be installed at the factory or can be installed during or after distribution by, for example, a downloading operation. The operations in accordance with the modules will be discussed in more detail below.

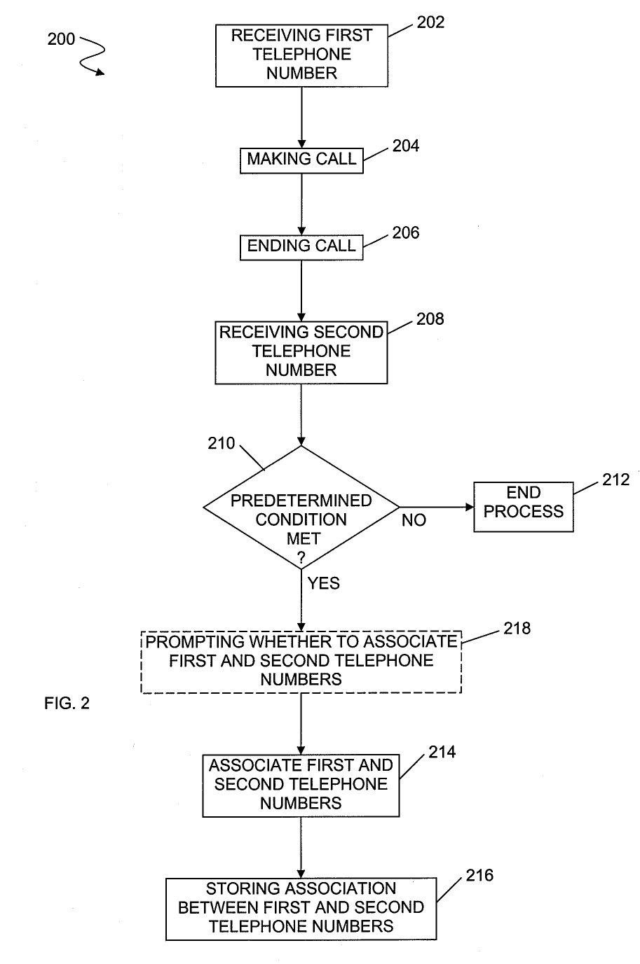

FIG. 2 is a flowchart 200 of an embodiment of a method for making an association between a first telephone number and a second telephone number. In making the association between a first and second telephone number, a first identifying address input, such as a telephone number is received 202. The first telephone number could be received via the keypad (110, see FIG. 1) or through accessing the telephone book (116, see FIG. 1) and selecting a telephone number. A first telephone call is initiated to a first telephone number 204. The first telephone call to the first telephone number eventually ends 206.

The method further includes receiving a second identifying address input, such as a telephone number 208 via the data input device such as a keypad (110, see FIG. 1) or by another method such as by accessing the telephone book (116, see FIG. 1). An association can be formed between the second telephone number and the first telephone number when predetermined conditions are met. For example, a query 210 can be initiated to determine if one or more predetermined conditions are met. For example, a predetermined condition could be that the call to the second number was made within a predetermined length of time from the ending of the first telephone call. The predetermined length of time may be, for example, between approximately two to ten seconds. A short time period between the calls may imply that the caller only reached an answering machine or that the caller did not reach the desired user (e.g., another person answered the dialed telephone or no one answered the dialed telephone). Accordingly, the timing module (122, see FIG. 1) may keep time between the ending of the first call and the receiving a second telephone number for the second telephone call. The timing module may also track the length of time of the first call.

In another embodiment, a predetermined condition may be ending the first telephone call when the first telephone call is an unanswered first call. In other embodiments, other predetermined conditions may include ending the first telephone call due to the first telephone call being answered by at least one of an answering machine, an answering service, a busy signal, an all circuits busy message, and a not-in-service message. The predetermined condition can additionally be: another telephone number is called immediately after the ending of the first telephone call. It is understood that other predetermined conditions are within the scope of this discussion. If the predetermined condition is not met, then the process ends 212.

Meeting a predetermined condition may determine whether the first and the second telephone numbers should be associated. The above-described association can be implemented using the association module (124, see FIG. 1). After the telephone numbers (the first identifying address and the second identifying address) are associated 214, they are stored in the memory (106, see FIG. 1) in the list containing links (118, see FIG. 1) between associated telephone numbers 216. The memory module (126, see FIG. 1) may be configured to store the associated first and second addresses in the memory (106, see FIG. 1) in any variety of manners. Optionally, the association query module (140, see FIG. 1) of electronic device provides a prompt to the caller requesting whether the association should be made 218.

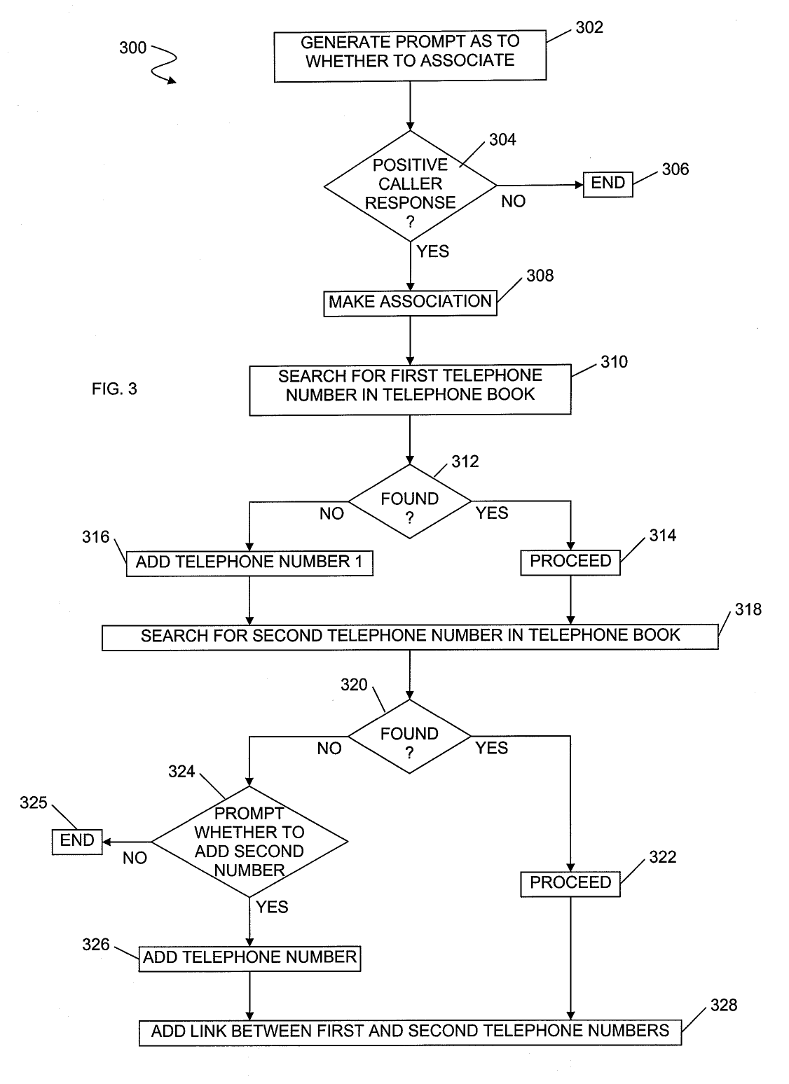

FIG. 3 is a flowchart 300 illustrating variations in the above-described method embodiments. As mentioned in reference to FIG. 2, an association between a first telephone number and a second telephone number is made (214, see FIG. 2). Prior to making the association, a prompt may be generated 302 (218, see FIG. 2) and displayed on a display screen (112, see FIG. 1) asking whether the caller wishes to make the association between the telephone numbers. If the response by the caller 304 is negative, the process ends 306. If the response by the caller 304 is positive, an association is made 308.

In this variation, the electronic device 102 searches for the first telephone number 310 in the telephone book (116, see FIG. 1) during the association process. If the first telephone number is found 312, then the process can proceed 314 to search for the second telephone number 318. If the telephone number is not found, then the first telephone number is added 316 to the telephone book 11 6. In this variation, the electronic device 102 also searches for the second telephone number 318 in the telephone book 116. If the second telephone number is found 320, then the process proceeds 322 to add links between the first and second telephone numbers 328. If the telephone number is not found, then an optional query 324 in the form of a prompt may be made. The prompt asks the caller whether to add the second telephone number to the telephone book. If not, the process ends 325. If yes, the telephone number is added 326 to the telephone book 116. Thus, both numbers may be entered into the telephone book 116 and linked together within the telephone book. An adding module (142, see FIG. 1) provides instructions for generating a prompt as to whether to add the associated second telephone number to a telephone book entry. One or more telephone numbers or addresses may be associated by links between the numbers 328 in a manner as discussed above or any other suitable manner.

In a similar manner, a plurality of telephone numbers may be associated with the first telephone number. In particular, a first telephone number may be associated with a second telephone number and a third telephone number. After one or more associations are made and stored, the electronic device (102, see FIG. 1) of the caller can automatically initiate one or more communications. A caller who would otherwise repeatedly make the same string of telephone calls to different telephone numbers after a first call to a first telephone number may be prompted to choose a telephone number from a list of one or more associated telephone numbers, or the device may automatically choose a telephone number with which to initiate a next call, based on the association of at least two telephone numbers.

In another embodiment, after a telephone number is associated with another telephone number, initiating a telephone call to either number will cause the retrieval of the other number at the end of the initiated telephone call. In another embodiment, after a plurality of telephone numbers are associated with one another, initiating a telephone call to any telephone number of the plurality will cause the retrieval of at least one of the other numbers at the end of the initiated telephone call. A default function and/or user preferences may provide that the association between two or more telephone numbers (for example, a first and a second telephone number) operates in the manner as discussed above and/or so that communication to any associated number can operate to retrieve one or all telephone numbers associated with the first called telephone number. In this manner, after an association is made, the retrieval of a telephone number based on the association may be provided for one or more associated numbers.

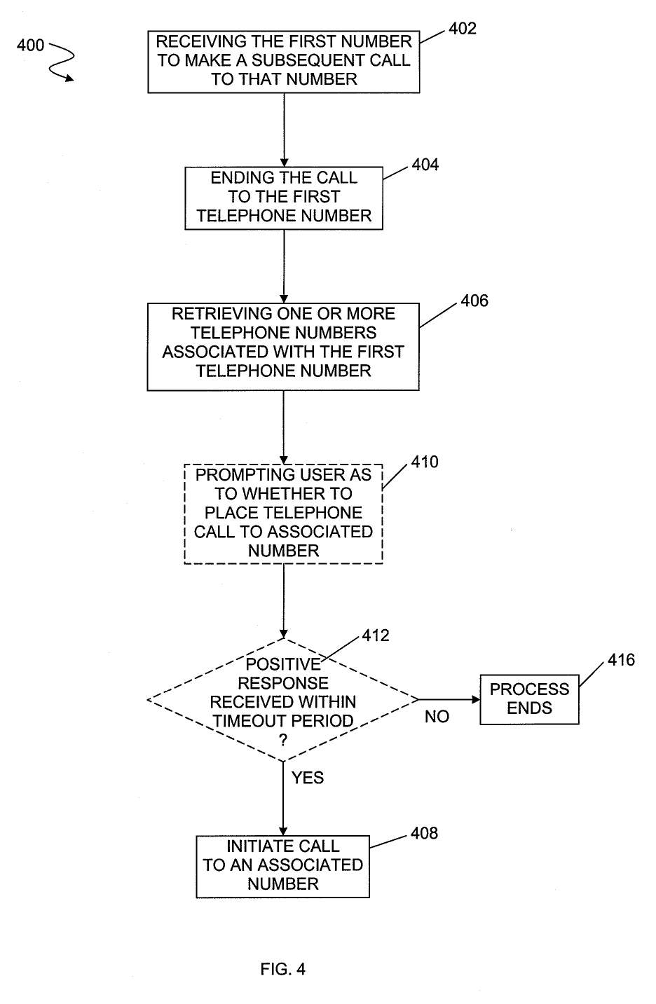

FIG. 4 is a flowchart 400 of an embodiment of the methods involving a plurality of previously associated numbers. As described above, the electronic device (102, see FIG. 1) receives a first telephone number to initiate a subsequent telephone call to the first telephone number 402. The call input module (123, see FIG. 1) processes the received first telephone number. At the end of the subsequent telephone call to the first telephone number 404, the electronic device 102 accesses the memory (106, see FIG. 1) to retrieve the association between the first telephone number and the second telephone number 406. The retrieving module (130, see FIG. 1) provides instructions to retrieve one or more associated telephone numbers from the memory 106. The electronic device 102 can then automatically initiate a telephone call to the associated second telephone number based on the association 408. The automatic dialing module (132, see FIG. 1) can provide instructions to automatically dial a retrieved associated telephone number.

FIG. 4 includes optional prompting as to whether to place the telephone call to the associated second telephone number 410. A prompting module (134, FIG. 1) provides instructions to generate a prompt. A response determination is made 412 so that if a positive response to the prompt is received with a predetermined timeout period as determined by a timeout module (136, FIG. 1), the device initiates a telephone call to the associated second telephone number based on the response 408. If no positive response is received within the predetermined period of time, the process ends 416.

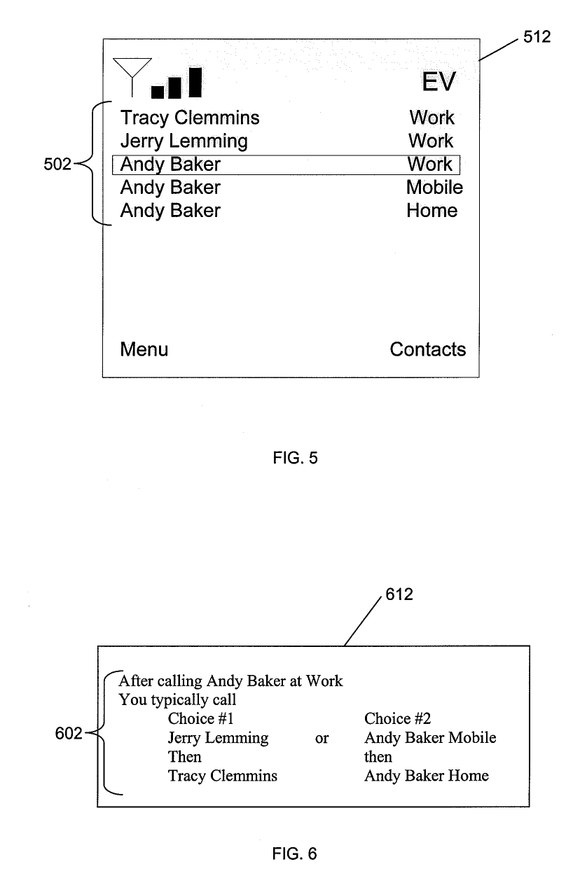

FIG. 5 depicts an embodiment of indicia 502 on a display screen 512 representing names associated with the telephone numbers. The indicia provided to the caller may be in any form such as visual, audio, tactile, or haptic. Displaying a plurality of names indicates that there can be several telephone numbers associated with the first telephone number. The first telephone number dialed may be Andy Baker—Mother's House, which is not shown. In this example, a telephone call to the first telephone number may have been initiated by accessing the telephone number from the telephone book (116, see FIG. 1). On the display screen 512, a list of telephone numbers associated with the first telephone number is represented 502 by names or any other suitable indicia. The contact list stored in the memory (118, FIG. 1) can be configured to contain a plurality of entries of telephone numbers so that entries contain a second telephone number and possibly a plurality of telephone numbers per entry of the list associated with the first telephone number. A contact list entry prompting module (138, see FIG. 1) can be configured to generate a prompt to choose between the associated second telephone number and the plurality of other telephone numbers per entry in which the associated second telephone number is contained.

In the example, a caller initiates a telephone call to the first telephone number. In placing a telephone call, first telephone call initiation indicia (114, see FIG. 1) representing a called first telephone number may be displayed on the display screen (112, see FIG. 1). The second telephone call indicia representing a retrieved second telephone number associated with the first telephone number are then displayed on the display screen 512 as illustrated in FIG. 5. As discussed in detail above, the second telephone number is associated with the first telephone number based on time between a termination of a previous telephone call to the first telephone number and a commencement of a previous telephone call to the second telephone number.

If a list of telephone numbers is associated with the first telephone number, a list of names 502 or other indicating indicia can be presented on the display screen 512 in response to ending the call to the first telephone number. Indicia on the display screen 502 may indicate that there are several numbers associated with the first telephone number. The list may be arranged according to frequency of choice by the caller, alphabetically, numerically, or in any other manner.

In one embodiment, the telephone numbers are arranged in statistical ordering. For example, when there are two telephone numbers associated with the first telephone number, a first statistical measurement is generated by statistically measuring how often the second telephone number is chosen as a response to the prompt. Additionally, a second statistical measurement may be generated by a statistical measurement of how often the third address is chosen as a response to the prompt. By correlating the first statistical measurement with the second statistical measurement to generate a correlated statistical output, the arrangement of the second address and the third address as presented to the caller can be based on the correlated statistical output. For example, the list of five entries 502 may have been arranged according to statistical ordering.

FIG. 6 illustrates another embodiment of indicia 602 on a display screen 612 indicating that there are several arrangements of lists of numbers associated with a first telephone number. In this embodiment, the display screen 612 presents two or more lists of indicia simultaneously or sequentially. The caller may provide a preference as to how to arrange the list or lists, or the list arrangement may be by default.

As described in detail above, the methods, devices, and user interfaces determine if an end of a first telephone call to a first telephone number and a commencement of a second telephone call to a second telephone number are within a predetermined period of time. If the telephone calls are within a predetermined period of time, an association may be formed between the first and second telephone numbers. The association may be automatic or by prompt. A user interface can include a display device for displaying indicia including first telephone call initiation indicia representing a called first telephone number and second telephone call indicia representing an automatically retrieved second telephone number associated with the first telephone number. The second telephone number was previously associated with the first telephone number based on time elapsed between a termination of a previous telephone call to the first telephone number and a commencement of a previous telephone call to the second telephone number. A caller may wish to associate all or some of the different telephone numbers of one party so that calling their different telephone numbers may be automatic. Also, in the situation where the caller repeatedly makes the same string of telephone calls to different parties, a caller may wish to associate telephone numbers of the different parties so that calling their telephone numbers in sequence may be automatic. Accordingly, repetitive look up of sequentially called telephone numbers can be avoided. Of course URLs, IP addresses, or other identifying symbols could replace the telephone numbers, and the target of the communication may be a website, server, or remote process in place of a person.

It is understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, discussion of such software and ICs, if any, is limited to the essentials with respect to the principles and concepts within the preferred embodiments.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. An electronic device utility method, the electronic device comprising at least one input device, memory, and a controller, the method comprising:
receiving a first identifying address input via the input device;
initiating a first communication to a first identifying address indicated by the first identifying address input;
ending the first communication;
receiving second identifying address input via the input device to initiate a second communication to a second identifying address indicated by the second identifying address input;
associating the second identifying address with the first identifying address when the second communication is initiated within a predetermined length of time from the ending the first communication to produce an association between the first identifying address and the second identifying address; and
storing in the memory the association between the first identifying address and the second identifying address.

2. The method of claim 1 where the first identifying address is a first telephone number and the second identifying address is a second telephone number.

3. The method of claim 1 wherein the first identifying address is at least one of a URL and an Internet protocol address.

4. The method of claim 1 further comprising:
determining if a predetermined condition is met.

5. The method of claim 4 wherein the predetermined condition is ending the first communication to the first identifying address within a predetermined time period.

6. The method of claim 4 wherein the predetermined condition is ending the first communication if the first communication is an unanswered first call.

7. The method of claim 4 wherein the predetermined condition is ending the first communication due to the first communication being answered by at least one of: an answering machine, an answering service, a busy signal, an all circuits busy message, and a not-in-service message.

8. The method of claim 1 wherein prior to associating, the method further comprises:
generating a prompt regarding whether to associate the second identifying address with the first identifying address.

9. The method of claim 1, further comprising:
receiving a subsequent first identifying address input via the input device to initiate a subsequent first communication to the first identifying address;
ending the subsequent first communication;
accessing the memory to retrieve the association between the first identifying address and the second identifying address; and
initiating, automatically, a subsequent second communication to the second identifying address.

10. The method of claim 1, further comprising:
receiving a subsequent first identifying address input via the input device to initiate a subsequent first communication to the first identifying address;
ending the subsequent first communication;
accessing the memory to retrieve the association between the first identifying address and the second identifying address; and
generating a prompt regarding whether to initiate a subsequent second communication to the associated second identifying address;
initiating the subsequent second communication to the second identifying address based on a positive response to the prompt.

11. The method of claim 1, further comprising:
receiving a subsequent first identifying address input via the input device to initiate a subsequent first communication to the first identifying address;
ending the subsequent first communication;
receiving a third identifying address input via the input device to initiate a third communication to a third identifying address indicated by the third identifying address input;
associating the third identifying address with the first identifying address when the third communication is initiated within a predetermined length of time from the ending the subsequent first communication to produce an association between the first identifying address and the third identifying address; and
storing in the memory the association between the first identifying address and the third identifying address.

12. The method of claim 11, further comprising:
receiving an additional first identifying address input via the input device to initiate an additional first communication to the first identifying address;
ending the additional first communication;
generating a prompt regarding whether to initiate a communication to at least one of the second identifying address and the third identifying address; and
initiating a communication to at least one of the second identifying address and the third identifying address based on a response to the prompt.

13. The method of claim 12, wherein the electronic device comprises a display device, the method further comprising:
statistically measuring how often the second identifying address is chosen as a response to the prompt regarding whether to initiate a communication to at least one of the second identifying address and the third identifying address to generate a first statistic measurement;
statistically measuring how often the third identifying address is chosen as response to the prompt regarding whether to automatically initiate a communication to at least one of the second identifying address and the third identifying address to generate a second statistical measurement;
correlating the first statistical measurement with the second statistical measurement to generated a correlated statistical output; and
positioning the second identifying address and the third identifying address on the display device based on the correlated statistical output.

14. An electronic device comprising:
a memory;
a timing module configured to determine if an end of a first communication to a first address and a commencement of a second communication to a second address is within a predetermined period of time; and
an association module configured to associate the first address with the second address to form associated first and second addresses when the end of the first communication and the commencement of the second communication occur within the predetermined period of time; and
a memory module configured to store the associated first and second addresses in the memory.

15. The electronic device of claim 14, further comprising:
a controller coupled to the memory;
an address input device coupled to the controller;
a call input module coupled to the address input device and configured to place a first communication to the associated first address; and
a retrieving module coupled to the controller configured to retrieve the associated second address from the memory when the first communication has ended.

16. The electronic device of claim 15, further comprising:
an automatic dialing call input module configured to automatically initiate a second communication to the associated second address when retrieved by the retrieving module.

17. The electronic device of claim 15, further comprising:
a prompting module configured to generate a prompt regarding whether to initiate a communication to the associated second address when retrieved by the retrieving module.

18. The electronic device of claim 17, further comprising:
a display device coupled to the controller; and
wherein the prompting module is configured to display the prompt on the display device.

19. The electronic device of claim 18, further comprising:
a timing out module for timing out the prompt after a predetermined time.

20. The electronic device of claim 14, further comprising:
a contact list stored in the memory, the contact list configured to contain a plurality of entries, wherein the associated second address is contained in an entry of the contact list, the entry containing a plurality of addresses; and
a contact list entry prompting module configured to generate a prompt to choose between the associated second address and the plurality of addresses in the entry where the associated second address is contained.

21. The electronic device of claim 14, further comprising:
an association query module for generating a prompt regarding whether to form an association between the first address and the second address.

22. The electronic device of claim 14, wherein the associated second address comprises an associated second telephone number, the electronic device further comprising:
a telephone book stored in the memory, the telephone book configured to contain a plurality of entries wherein each of the plurality of entries allows storage of at least one telephone number; and
an adding module for generating a prompt regarding whether to add the associated second telephone number to a telephone book entry.

23. A user interface of a communication device, comprising:
an annunciation device for presenting indicia;
first communication initiation indicia representing initiation of communication to a first address; and
second communication indicia representing an automatically retrieved second address associated with the first address;
wherein the second address is associated with the first address based on time between a termination of a previous communication to the first address and a commencement of a previous communication to the second address.

24. The user interface of claim 23, wherein the second communication indicia further comprises a list of addresses associated with at least one of the first address and the second address.

25. The user interface of claim 23, wherein the list of addresses associated with at least one of the first address and the second address are associated using an address book stored in a memory of the communication device.

26. The user interface of claim 23 wherein the second communication indicia includes a prompt presented on the annunciation device for a predetermined period of time.
